(19) United States
(12) Patent Application Publication
(10) Pub. No.: US 2009/0020444 A1
(43) Pub. Date: Jan. 22, 2009

(54) Shoebox Photo Id System

(76) Inventor: Rainey Green, Dumfries, VA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/087,105

(22) PCT Filed: Dec. 28, 2006
(86) PCT No.: PCT/US2006/049402

§ 371 Date: Jun. 26, 2008

Related U.S. Application Data
(60) Provisional application No. 60/755,074, filed on Jan. 3, 2006.

(51) Int. Cl. B65D 85/18; G09F 3/00; B31B 49/00

(52) U.S. Cl. 206/281; 40/312; 493/320

(57) ABSTRACT

The shoebox photo ID system is a shoebox (5) that has a plurality of end panels (10), a plurality of lateral side panels (15), a bottom, and a lid (25). Attached to at least one of the panels of the shoebox (5) is a pouch (30) adapted for removably holding and displaying a specially prepared photograph (35). The photograph (35) includes at least one view of the pair of shoes in the shoebox (5), thus enabling a consumer to easily identify the pair of shoes in the shoebox (5) by viewing the attached photograph (35). An alternative embodiment includes an additional photograph (20) of the pair of shoes permanently attached, embossed or printed on the shoebox panel.

### TECHNICAL FIELD

The present invention relates to the packaging of shoes, and particularly to a shoebox photo ID system to provide visual identification of the shoes contained in the shoebox.

### BACKGROUND ART

Generally, shoes are packed in cardboard boxes for storage, transportation, protection, and the like. Such shoeboxes are stocked in shoe factories for packaging purposes. Additionally, for consumers who buy large numbers of shoes, infrequently used shoes often end up in their original boxes, stacked up in the consumers' closets.

However, since the shoeboxes are not transparent, they do not allow for easy identification of the model, color and size of the shoes stored therein. Usually, the model, color and size indications are written on the shoeboxes, but for a consumer who is trying to match a pair of shoes with a particular outfit, a textual color, model, and size designation may not provide enough information upon which to make an outfit matching decision. Moreover, if the consumer desires to shop for a matching outfit, it would be very inconvenient for the consumer to take the shoes with him/her either in the box or out of the box. Hence, the typical shoebox does not allow for easy identification and matching of its contents.

Thus, a shoebox photo ID system solving the aforementioned problems is desired.

### DISCLOSURE OF INVENTION

The disclosure is directed to a shoebox photo ID system. The system shoe box has a plurality of panels that define the ends, lateral sides, and bottom of the shoebox. A removable lid covers the open top of the shoebox. A pair of are shoes contained within the shoebox. A pouch with a transparent side is attached to at least one of the panels of the shoebox. At least one viewable photograph of the shoes is disposed in the pouch so that the consumer can easily identify the pair of shoes in the shoebox by viewing the photograph

The disclosure is also directed to a method for creating a shoebox photographic identification system. In accordance with the method, during the manufacturing process, a run of shoes is associated with a run of die cut box patterns during box production. An image of the shoes is created and transmitted to the associated die cut box pattern so that the image of the shoes is printed on the associated die cut box pattern. A hard copy of the photograph is also created. A photograph-receiving pouch is created on the associated die cut box pattern and the hard copy of the photograph is placed in the photograph-receiving pouch Shoes may then be placed in the shoebox.

### BRIEF DESCRIPTION OF THE DRAWINGS

FIG. 1 is an environmental, perspective view of a shoebox photo ID system according to the present invention.

FIG. 2 is a perspective view of the shoebox with photo ID system according to the present invention.

FIG. 3 is a front view of an alternative embodiment of a shoebox with photo ID system according to the present invention.

FIG. 4 is a flowchart of a shoebox photo ID method according to the present invention.

Similar reference characters denote corresponding features consistently throughout the attached drawings.

### BEST MODES FOR CARRYING OUT THE INVENTION

The shoebox photo ID system is a shoebox that has a plurality of end panels, a plurality of lateral side panels, a bottom, and a lid. Attached to at least one of the panels of the shoebox is a pouch adapted for removably holding and displaying a specially prepared photograph.

The photograph includes at least one view of the pair of shoes in the shoebox, thus enabling a consumer to easily identify the pair of shoes in the shoebox by viewing the attached photograph. An alternative embodiment includes an additional photograph of the pair of shoes permanently attached, embossed or printed on one of the shoebox panels.

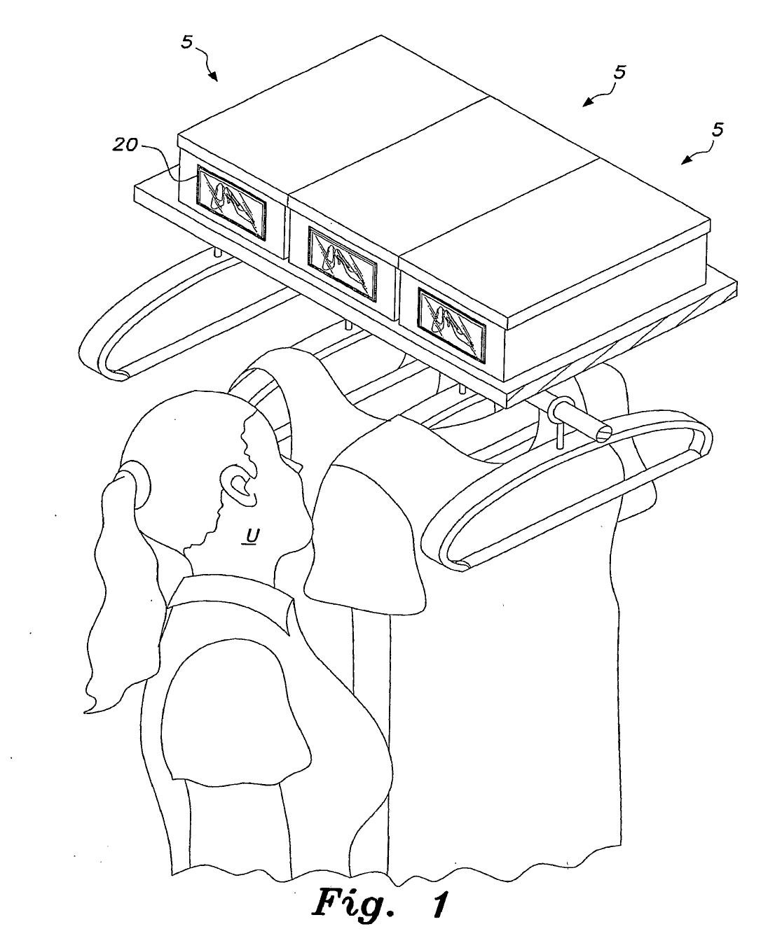

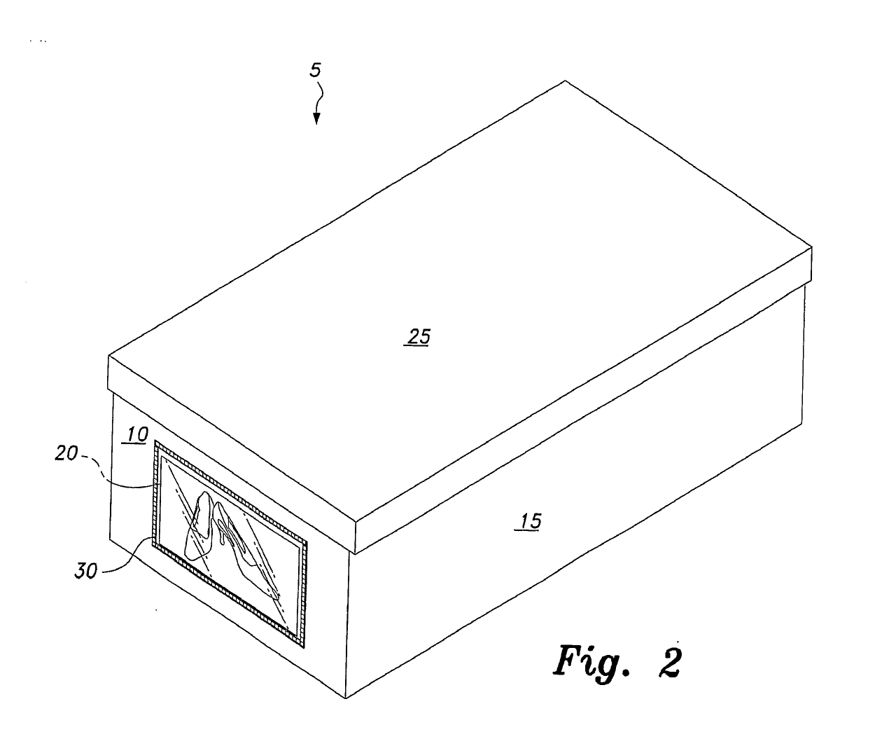

As shown in FIGS. 1-3, the shoebox 5 that has a plurality of end panels 10, a plurality of lateral side panels 15, a bottom, and a lid 25. Attached to at least one of the panels of the shoebox 5 is an exterior pouch 30 adapted for removably holding a color photograph, such as removable photo ID 35.

The front side 42 of exterior pouch 30 may be comprised of any transparent or substantially translucent, preferably durable, material. For example, a substantially transparent polymer is suitable for adaptation as an exterior pouch 30 front side 42 to hold and display a photograph, such as removable photo ID 35, in place on shoebox end panel 10. Pouch backing material 40 may be of similar construction, but does not have to be transparent or translucent.

Exterior pouch 30, including front side 42 and backing material 40, may be sewn, stapled, glued, or otherwise affixed to a shoebox panel, such as shoebox end panel 10, or alternatively, to lateral shoebox side panel 15.

The photograph 35 is specially prepared, i.e., photograph 35 includes at least one view of the pair of shoes in the shoebox 5, thus enabling a consumer to easily identify the pair of shoes in the shoebox 5 by viewing the attached photograph 35. Preferably the specially prepared photograph 35 includes at least a front view and a side view of the shoes contained inside of the box 5. The photo may be removable from pouch 30.

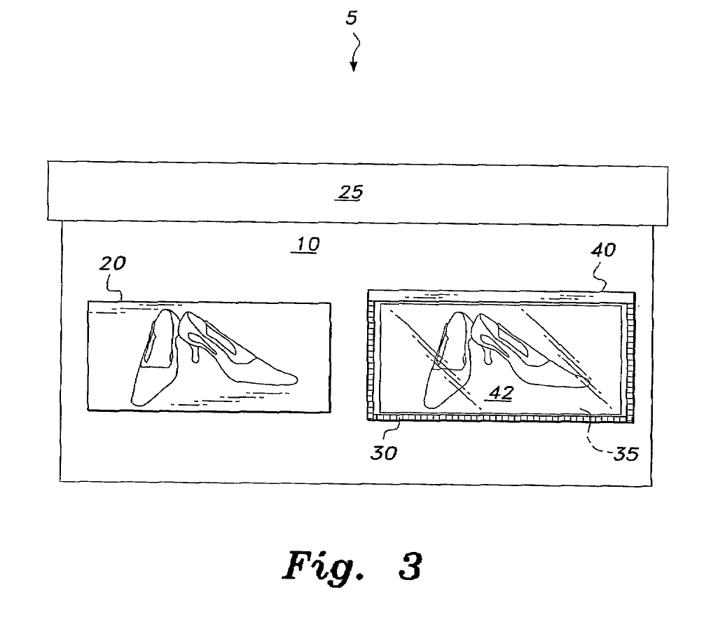

As shown in FIG. 3, an alternative embodiment of the shoebox photo ID system includes an additional specially prepared photograph, i.e., photographic indicia of the pair of shoes 20 permanently attached, embossed, printed, or otherwise permanently disposed on the shoebox side panel, such as end panel 10.

The photograph configuration, as shown in FIG. 3, advantageously allows for a user U to remove the photograph 35 from the exterior pouch 30 to go shopping with, and subsequently return the photograph 35 to the appropriate box 5 by visually matching up the removable photograph 35 with the permanently attached photograph 20.

Creation of shoebox photographic ID system 5, including photographs, such as permanent color photograph 20 and removable photograph 35 may be done in the shoe manufacturing and box production phase, i.e., during assembling and packaging, before the shoe reaches a consumer, such as user U.

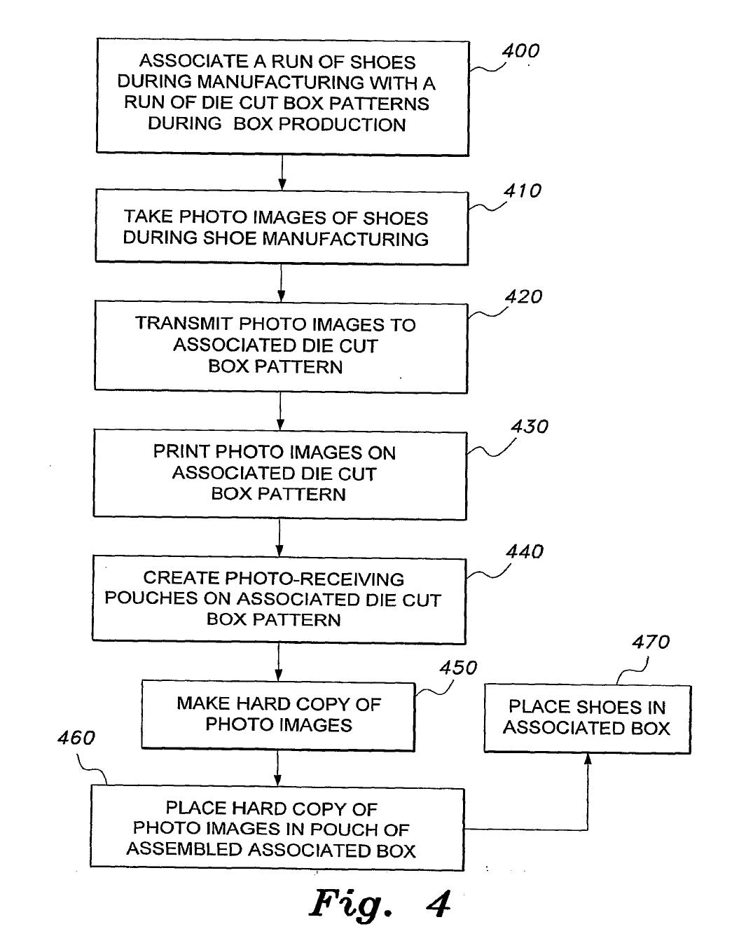

For example, as shown in FIG. 4, the present invention provides for a sequence of steps to create the photo ID system 5. Step 400 provides for associating a run of shoes during manufacturing with a run of blanks, i.e., die cut box patterns during box production.

In step 410, photo images of the shoes are taken. The photographic images may be taken in an automated, preferably digital, format. Alternatively, the photographic images may be manually taken.

Step 420 provides for transmitting the photo images to the associated die cut box pattern. Step 430 includes printing the photo images on the associated die cut box pattern, preferably on a panel, such as end panel 10 of box 5.

Step 440 includes creating at least one photograph receiving pouch 30 on the associated die cut box pattern. As shown in step 450 of FIG. 4, at least one actual “hard copy” photograph is made. In step 460 the hard copy photograph is placed in the pouch 30 of the box. Step 470 completes the process by placing the shoes in the box 5.

It is to be understood that the present invention is not limited to the embodiments described above, but encompasses any and all embodiments within the scope of the following claims.

1. A shoebox photo ID system, comprising:
a shoebox having a plurality of end panels, a plurality of lateral side panels, and a bottom defining a shoebox, and a removable lid covering an open top of the shoebox;
a pair of shoes contained in the shoebox;
a pouch attached to at least one of the panels of the shoebox, the pouch having a transparent viewing side; and
at least one photograph disposed in the pouch, the photograph being viewable through the transparent viewing side, the photograph showing an image of the shoes;
whereby, a consumer may easily identify the pair of shoes in the shoebox by viewing the photograph thereof.

2. The shoebox photo ID system according to claim 1, further comprising: photographic indicia representing the at least one view of the pair of shoes; the photographic indicia being permanently disposed on the at least one of the side panels of the shoebox.

3. The shoebox photo ID system according to claim 1, wherein the pouch is made of a substantially transparent polymer.

4. The shoebox photo ID system according to claim 1, wherein the pouch is sewn to the shoebox.

5. The shoebox photo ID system according to claim 1, wherein the pouch is glued to the shoebox.

6. The shoebox photo ID system according to claim 1, wherein the pouch is stapled to the shoebox.

7. The shoebox photo ID system according to claim 1, wherein the photograph is a color photograph.

8. A method for creating a shoebox photographic identification system, comprising the steps of:
associating a run of shoes during manufacturing with a run of die cut box patterns during box production;
creating photo images of the shoes;
transmitting the photo images to the associated die cut box pattern;
printing the photo images on the associated die cut box pattern;
creating at least one photograph-receiving pouch on the associated die cut box pattern;
making a hard copy photograph;
placing the hard copy photograph in the pouch of the shoebox; and
placing the shoes in the shoebox.

9. The method for creating a shoebox photographic identification system according to claim 8, wherein the step of creating of the photo images comprises creating digital image format images.

10. The method for creating a shoebox photographic identification system according to claim 8, wherein the step of printing of the photo images on the die cut box pattern disposes the images on a panel of the shoebox.

11. A method for creating a shoebox photographic identification system, comprising the steps of:
associating a run of shoes during manufacturing with a run of die cut box patterns during box production;
creating photo images of the shoes;
printing the photo images on the associated die cut box pattern;
creating at least one photograph-receiving pouch on the associated die cut box pattern;
making a hard copy photograph;
placing the hard copy photograph in the pouch of the shoebox; and
placing the shoes in the shoebox.

12. The method for creating a shoebox photographic identification system according to claim 11, wherein the step of creating of the photo images comprises creating digital image format images.

13. The method for creating a shoebox photographic identification system according to claim 11, wherein the step of printing of the photo images on the die cut box pattern disposes the images on a side panel of the box.
